(19) United States
(12) Patent Application Publication
(10) Pub. No.: US 2020/0250694 A1
(43) Pub. Date: Aug. 6, 2020

(54) MATCHING OFFERS TRANSACTIONS ACROSS HETEROGENEOUS, MULTI-ENTITY DISTRIBUTED COMPUTING PLATFORMS AND SETTLEMENT

(71) Applicant: DOSH HOLDINGS, INC., Austin, TX (US)

(72) Inventors: Ed MOCK, Austin, TX (US); Ryan WUERCH, Austin, TX (US)

(21) Appl. No.: 16/854,693

(22) Filed: Apr. 21, 2020

Related U.S. Application Data
(63) Continuation of application No. PCT/US2018/065011, filed on Dec. 11, 2018.
Application No. PCT/US2018/065011 is a continuation-in-part of application No. 15/486,769, filed on Apr. 13, 2017.
Application No. 15/486,769 is a continuation-in-part of application No. 15/375,979, filed on Dec. 12, 2016.
Application No. 15/375,979 is a continuation-in-part of application No. 15/375,866, filed on Dec. 12, 2016.
Application No. 15/375,866 is a continuation-in-part of application No. 15/375,705, filed on Dec. 12, 2016.
(60) Provisional application No. 62/597,126, filed on Dec. 11, 2017.
(60) Provisional application No. 62/712,399, filed on Jul. 31, 2018.

(51) Int. Cl. G06Q 30/02; H04L 9/32; G06Q 30/06; G06Q 50/00; G06Q 20/40; G06F 16/958

(52) U.S. Cl. CPC G06Q 30/0211; H04L 9/3213; G06Q 30/0611; G06Q 50/01; G06Q 2220/00; G06Q 30/0268; G06Q 30/0235; G06Q 20/40; G06F 16/958; G06Q 30/0277

(57) ABSTRACT

A system and method for matching transactions across heterogenous, multi-entity distributed computing platforms are disclosed. In more detail, a system and method for matching and settling offers in a computerized system involves receiving a plurality of created offers, receiving logic for honoring one or more of the plurality of created offers, creating a plurality of tokens and associating each of the plurality of offers with one or more of the created tokens, distributing one or more of the created offers through electronic messages to a plurality of potential customers, receiving an indication that a consumer has selected at least one of the plurality of offers, linking the consumer with a token associated with the selected at least one offer, upon a consumer transaction, deploying the logic for honoring offers to determine whether the selected offer will be honored; and receiving messages related to the propagation or efficacy of the offer.

### PRIORITY CLAIMS/RELATED APPLICATIONS

This application claims the benefit under 35 USC 119(e) and 35 USC 120 to U.S. Provisional Patent Application Ser. No. 62/597,126 on Dec. 11, 2017 and entitled “Matching Transactions Across Heterogeneous, Multi-Entity Distributed Computing Platforms” and U.S. Provisional Patent Application Ser. No. 62/712,399 filed Jul. 31, 2018 and entitled “Offers Matching and Settlement” and further is a continuation in part and claims priority under 35 USC 120 to U.S. patent application Ser. No. 15/486,769, filed Apr. 13, 2017 entitled System for Generating and Tracking Offers Chain of Titles, U.S. patent application Ser. No. 15/375,979, filed Dec. 12, 2016 entitled System for Generating and Tracking Offers Chain of Titles, U.S. patent application Ser. No. 15/375,866, filed Dec. 12, 2016 entitled System for Sharing and Transferring Currency and U.S. Patent application Ser. No. 15/375,705, filed Dec. 12, 2016 entitled System for Identifying and Applying Offers to User Transactions, all of which are incorporated herein by reference in their entirety.

### FIELD

The present disclosure relates generally to computing and, more specifically, to matching transactions across heterogenous, multi-entity distributed computing platforms. The present disclosure further relates to systems for inducing customers to have business interactions, more specifically for linking merchant marketing plans to specific customers actions for tracking and settlement of the marketing plan.

### BACKGROUND

Multi-entity distributed computing platforms are used in a variety of contexts. Examples include social networks, massive-multiplayer video gaming systems, public blockchain technologies, messaging systems, ad networks, credit card processing computer systems, affiliate networks, and the like. These systems generally process various types of transactions on behalf of a relatively large number of entities, such as users, customers, merchants, and the like.

Platform-specific transactions often correspond to real-world events, and those events can, in many cases, correspond to transactions on multiple platforms. Traditional computer systems are not well suited for matching transactions across computing platforms, particularly at commercially relevant scale (which can exceed tens of millions of users engaging in millions of transactions per day) with commercially acceptable latency.

Furthermore, merchants promote their businesses frequently through advertising and marketing techniques that are calls to action by the consumer, including offering particular marketing campaigns, offers and promotions. These offers tend to multiply, making multiple offers relevant to a single business interaction, such as a purchase of goods. Merchants have the difficulty in present systems of tracking the appropriate offer to settle and to coordinate between the approval of or rejection of multiple offers for the same transaction.

Similarly, a consumer may be exposed to or interact with multiple offers or marketing messages before the consumer conducts a business interaction, such as a purchase. The merchant in prior art methods has limited information regarding the efficacy of any individual offer or message in inducing the consumer into a business interaction.

### SUMMARY

The following is a non-exhaustive listing of some aspects of the present techniques. These and other aspects are described in the following disclosure. Some aspects include process of matching transactions across heterogenous, multi-entity distributed computing platforms.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

Some aspects include a method and systems for the linking of specific merchant marketing/advertising/offers campaigns to consumer impression/receipt and associated transaction events across multiple mediums including online, on-mobile, in-store, and in-social and across multiple points of transaction including in-store, online, in-app, and in-social. The services associated with technology enable validation of offers/coupons/discount codes presented and the application of merchant and or publisher defined rules for the honoring, authorization, and settlement of offers/coupons/discounts.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an embodiment of a computing environment in which the present techniques may be implemented in accordance with some embodiments;

FIG. 2 is a representation of certain of the major features of certain embodiments of the present disclosure, including the campaign creation, campaign and offer propagation, and clearinghouse service and market monitor;

FIG. 3 is a representation of an embodiment of the system disclosed herein, showing certain different logic to be used in the offer matching, qualification and settlement features of the present disclosure;

FIG. 4 is a representation on one application of certain embodiments of the disclosure, where an offer is viewed by the consumer, tracked, and redeemed; and

FIG. 5 is an example of a computing device by which a portion of the techniques herein may be implemented, the techniques herein frequently encompassing the use of multiple computing devices.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF ONE OR MORE EMBODIMENTS

To mitigate the problems described herein, the inventors had to both invent solutions and, in some cases just as importantly, recognize problems overlooked (or not yet foreseen) by others in the field of computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Failure or inability to reliably match transactions across multi-entity distributed computing platforms can lead to undesirable outcomes. For example, merchants often seek to reward publishers, rewards program managers, and other third-party marketers who drive customers to the merchants, e.g., with affiliate compensation programs or other contractual rewards. But in many cases, different entities that contribute to a customer purchase are associated with different transactions on different multi-entity distributed computing platforms.

As a result, it can be difficult to allocate credit among these parties. The different transactions may correspond to the same real-world event, e.g., a purchase online or offline, but matching the transactions is typically not computationally feasible with existing systems, in part because of scaling and latency challenges, and in part because the different platforms have heterogenous data formats, data models, and operate asynchronously. As a result, merchants often fail to understand how different third parties contribute toward a purchase, and merchants risk double-compensation of those third parties for the same event where compensation determinations are based on data on different multi-entity distributed computing platforms.

For example, a customer could 1) discover a merchant's offering on a first entity's mobile app; 2) research reviews of the entity on a second entity's website, 3) select the item in the website causing an affiliate network to credit the entity in a cookie, and 4) purchase the item on a merchant's website with a credit card tied to a rewards program, causing A) an affiliate network to read the cookie and determine the second entity should be compensated for the purchase, B) cause a second entity associated with the rewards program to be compensated for the same event, and C) failing to compensate the first entity. Double compensation, or improper allocation of attribution for an event, is an undesirable consequence of the capabilities of many conventional multi-entity distributed computing platforms used to process these types of events. Or, if the purchase is in-store, both the first and the second entity may not receive credit toward an event that they helped facilitate.

In other examples that serve to emphasize the breadth of the issue, a data breach may lead to an arrangement of transactions (like fraudulent purchases and fraudulent creation of user accounts) that, if properly matched, would be clearly anomalous, signaling to security professionals that remedial action should be taken. Absent matching transactions, data breach may affect users longer than is necessary. In another example, side-channel messaging on a messaging platform during a multi-player gaming session may indicate cheating that, in the absence of matching, goes undetected, impairing the gaming experience for others. In another example, marketing efforts of merchants are often constrained by inability to match transactions across platforms.

Matching across multi-entity distributed computing platforms is often particularly challenging due to inconsistent name-spaces across platforms, inconsistent data models across platforms, and asynchronous operation of the platforms relative to one another. A given user may be uniquely identified with a different user identifier on different platforms. And that user's transactions may be represented differently across platforms, e.g., as a single entity in one platform and as a collection of accounts on another, or as a shared account between two users.

Further, one platform may process a transaction corresponding to a given event at a different time from another platform responding to that same event (which may span several days or weeks, and include a sequence of transactions that culminate in something like a purchase or other terminating transaction). Aggravating the issue, many multi-entity distributed computing platforms process millions of events or more per day or hour, causing the computational resources consumed by the matching problem to scale beyond what is commercially feasible to address with more naive approaches. For instance, in the payments space, a given payments network may have more than 30 million merchants, with more than 200 million consumers in the US, and every consumer may have more than 5 to 10 accounts on different platforms where relevant transactions might occur.

To mitigate these issues or others, some embodiments may implement a multi-platform matching engine that ingests transactions from multiple platforms and matches, in some cases probabilistically, transactions on different platforms to one another based on a likelihood that those matched transactions correspond to the same event. Example use cases are described with reference to multi-channel attribution for merchants seeking to manage incentives for affiliates and rewards programs across multiple channels, but it should be emphasized that the present techniques have uses cases in other domains (like cyber security, and community management in games and social networks) and are not directed to merely attributing credit for marketing across channels. Some embodiments afford a relatively scalable (e.g., into the millions of events or transactions per day our hour range or higher), auditable, verified attribution of actions by various entities (like publishers, marketers, affiliates, and rewards programs) to a given event (like a purchase of a good or service from a merchant by a consumer exposed to the actions) across multiple channels (like in native mobile applications, websites, social media, etc.). And some embodiments match these events and provide attribution in cross-platform sets of transactions that include a particularly technically challenging channel: payments networks, like those provided by Visa™, MasterCard™, Venmo™, WeChat™, and various digital wallet operators. Payments network data is often more constrained in the amount of information available and higher latency, but may extend the range of data acquisition out of the online realm, in some cases, to in-store transactions, making these transactions particularly useful for analyzing events.

To these ends and others, some embodiments of the matching engine implement a set of software-implemented interfaces to one or more computer-implemented payments networks, one or more digital network operators, one or more affiliate networks, and one or more merchants. These interfaces may include code configured to obtain data via corresponding application program interfaces of these various third party multi-entity distributed computing platforms. The obtained data may describe transactions on those platforms. Received transaction records may include a unique transaction identifier, a user identifier, an account identifier (or pair of account identifiers where a transaction is sharing of content between two members of a social network), an event identifier, a timestamp of the event, an item subject to the transaction, a merchant identifier, an entity other than a consumer to which credit is attributed, an timestamp of the transaction, a platform identifier, a campaign identifier, an advertisement or offer identifier (in some cases, specific to a publisher or affiliate), a list of stock-keeping unit identifiers subject to the transaction, and the like (e.g.,. each in a namespace of the respective platform, which may differ among the platforms), depending on the platform. Some embodiments may be configured to pull data from a given platform, e.g., responsive to receiving data about a transaction on another platform, or periodically, responsive to determining that a threshold amount of time has elapsed. Some embodiments may register in various platform APIs to subscribe to transaction interrupts (e.g., signals indicative of a transaction) pushed to the matching engine.

In some cases, data is retrieved from third party platform servers, or some embodiments may retrieve data from client devices interacting with those servers. For instance, some platforms may embed a script in content sent to client devices (e.g., JavaScript™ in web pages) (or in native apps), and that script may compare items interacted with by consumers in a web page (or native app), e.g., viewed, shared, commented upon, rated, selected, added to a cart, or bought, to a set of items of interest (e.g., those for which other transactions exist, offers are available, or are monitored) and upon detecting a match, send a corresponding transaction record to the matching engine.

Some embodiments execute a translation algorithm operative to translate data in various third-party platform formats into a unified format of the matching engine. Some embodiments ingest, parse, validate, and normalize incoming data. Some embodiments translate data from one of a plurality of platform-specific inbound schemas into a schema of a unified data format for transactions of the matching engine. Upon ingesting transaction records from a given platform, some embodiments may validate and normalize the inbound data. To this end, some embodiments may retrieve from memory a platform-specific schema definition, and apply a plurality of criteria in the platform-specific schema to determine whether any criteria are violated, e.g., as encoded in a JSON Schema document, XML Schema document, or other document type definition language. Examples include detecting required fields that are absent, fields that must be in integer format having non-numeric characters, fields that should be in a particular format that satisfies a regular express (like that of a phone number or email address) that do not satisfy the regular expression, or the like.

After validating, some embodiments may retrieve from memory a schema-translation specification, e.g., encoded in XSLT, parse the inbound data and the specification, and translate the data between schemas based on the specification. This may include re-mapping field names or key-identifiers in key-value pairs. In some cases, in-bound data may be received in a hierarchical serialized data format, like XML or JSON, and data may be translated into another hierarchical serialized data format document with a different schema, or into key-value pairs, a relational database, or other data repository schema. Some embodiments may store the resulting translated data in a unified transaction repository, e.g., with a field indicative of whiter the respective records have been analyzed for cross-platform matches set to false.

Some embodiments of the matching engine may then retrieve un-analyzed transaction records and attempt to match those transactions to other transactions on other platforms corresponding to the same event and having corresponding transaction records stored in the unified transaction repository. Upon completing the analysis, some embodiments may update the above described filed with a true value indicating the record has bene analyzed. Some embodiments may determine whether a new transaction record corresponds to a new event, e.g., by privileging records from a given platform as canonical event descriptors, or by determining that the transaction record does not match transaction records of any existing events. Upon detecting a new event, some embodiments may associate with the transaction record a unique event identifier (in a namespace of the unified transaction repository or using an identifier from platform designated as canonical). Upon detecting matches to transaction records of existing events, some embodiments may augment transaction records that match one another with the event identifier. Some embodiments may also update an index that associates event identifiers with addresses of transaction records to facilitate faster data retrieval.

Transactions may be matched to one another, and as therefore corresponding to the same event, by the matching engine. A single event may have more than two, three, four, five, ten, twenty, or more time-stamped transactions on two, three, four, five, or more platforms. In some cases, matching may include joining of multiple tables or chaining identifiers in three or more fields. For instance, matching may include matching a tender id to a merchant id, which may be used to select an affiliate id, and then a device id, which may then be matched to a transaction record referencing that device id. Examples of fields upon which matches may be based include a merchant id, a stock keeping unit or universal product code, affiliate network identifiers, offer identifiers, rewards identifiers, payment tender identifiers (e.g., PayPal™ id or 16-digit code), domain name servers, unique device identifiers (UDIDs), user identifiers on different platforms that deliver web applications, like those offered by Google™ or Apple™. In some cases, sets of candidate matches may be selected based on values like merchant identifiers, and then probabilistic matching or exact matching may be performed within those candidates, e.g., based on geolocation, time, user-agent string information, and the like.

For example, a purchase through a payment network in-store may cause a transaction record (e.g., corresponding to and generated in the course of authorizing a purchase) to be sent to the matching engine. The matching engine, in response, may parse from the transaction record a merchant identifier, a tender type, and a user identifier. Some embodiments may further obtain level 3 data, such as SKUs or UPC's of what was purchased and values describing coupons and other offers redeemed in the purchase. In some cases, merchants and affiliate networks may register with the matching engine and upload descriptions of offers and rewards. Some embodiments may match the merchant identifier to offers registered to that merchant, and those offers may be associated with respective affiliates. Some embodiments may query the transaction records for transactions in which corresponding affiliates provided corresponding offers, rewards, content or the like to the given user to identify matches across platforms. In some cases, a payment network transaction may include a store id, and some embodiments may access a geographic information system to determine a geolocation of the store. In some cases, that geolocation may be used to select among candidate transaction matches on other platforms. Some embodiments may match to content exposure on social networks or ad networks, e.g., by associating user identifiers on these different platforms and on payment networks with a global unique identifier of users maintained by the matching engine.

Examples of matches that may be performed include matching consumer global unique identifiers (within the namespace of the matching engine) to social network id's of a user (of which there may be several for a given user on different platforms); matching offer id of an offer registered by an affiliate network or merchant to an offer id in purchases and exposure transactions; matching affiliate identifiers to a point of exposure; and matching affiliate network hosted offers to merchant-redeemed offers.

Some embodiment may also classify events as being associated with campaigns. In some cases, after matching transactions to one another in collections of transaction records descriptive of events (which may correspond to different occurrences on a consumer's journey toward a single purchase event), those events may be classified into campaigns. In some cases, merchants may register campaigns and thereby supply criteria by which events are classified into campaigns, e.g., a particular content identifier must appear in a transaction record for an ad impression transaction, or ad click-through transaction. Or a particular event must also occur within a duration of time and geographic area specified by the criterial. Or in some cases, transaction records may include campaign identifiers mapped to the transaction by the respective multi-entity distributed computing platforms from which data describing the transaction was ingested.

In some cases, transaction records may be associated in memory of the unified transaction repository with campaign identifiers of campaigns having criteria satisfied by the respective transaction or event for which it is descriptive. Some embodiments may update a campaign index that associates campaign identifiers with respective lists of addresses of the transactions or events in those campaigns to facilitate faster data retrieval. In some cases, the unified transaction repository is a noSQL (nonrelational) database selected to afford flexibility with respect to evolving data models and speed for certain queries. In some cases, the database may be a Redis™ in-memory key-value pair database, which is expected to afford flexible data Models and relatively low-latency, hardware-failure resistant data storage and retrieval.

Some embodiments may implement real-time transaction mapping across these platforms, e.g., between a payment provide platform and an affiliate network, or any permutation of the above-listed examples of platforms. In some cases, matching may be achieved within less than 15 minutes, e.g., less than 10, 5, or 1 minute of a later-pair of a matched pair of transaction records being ingested. Some embodiments may match within less than 30 seconds, e.g., less than 10 seconds or 500 milliseconds.

Within each of the groups of matched transactions corresponding the same respective event, some embodiments may detect duplicative bases for seeking compensation by different entities contributing toward the same respective event on different platforms. For instance, some embodiments may detect that both A) a publisher on an affiliate network provided content by which a user clicked-through to a merchant webpage (thereby generating a transaction record corresponding to cookie set on a user's computing device by the affiliate network and read by the affiliate network upon the user making a purchase on the merchant's website to credit the purchase to the publisher for compensation)and B) an entity running a rewards program that operates on payment network transactions for a credit card used by the user to make the purchase on the merchant's website. Some embodiments may flag these two transactions as a potential duplicative-compensation risk, and send data uniquely identifying the pair to the merchant, the affiliate network, the publisher, or the entity providing the rewards program, to cause those entities to adjust compensation accordingly (e.g., splitting a compensation budget, or only rewarding one of the two) and explain the adjustment.

Some embodiments may match a plurality of compensable transactions to the same event and dynamically allocate different percentages of compensation for the event to different ones of the entities effectuating those transactions. In some cases, the percentages are based on a machine learning model that infers a causal contribution of the respective entities toward the event. Some embodiments may train a machine learning model (or perform principal component analysis) (such as a forward propagating neural network, a recurrent neural network, or a hidden

Markov model) on historical transaction records and construct a trained model that allocates causal credit for an event based on historical efficacy of different similar transactions. For instance, if a given transaction of a user clicking through from a publisher's website occurs in many events, only a small portion of which result in a purchase transaction for a given product, that publisher's transactions may be assigned less credit than, for instance, a reward's program that drives a substantial difference in purchase rates between products or customers in the rewards program and those outside the rewards program. In some cases, attribution may include attribution credit (e.g., 100% in some cases) to an online publisher or mobile application for an in-store purchase based on a payments network transaction, which is a form of attribution generally not supported by traditional affiliates networks. In some cases, older transactions may be removed (e.g., older than a threshold duration, like one week° or down weighted (e.g., with a half-life calculation) in credit allocation.

Some embodiments may determine whether to provide a reward, e.g., based on whether double compensation is an issue, or determine an amount of a reward. In some cases, this may include providing a reward with the platforms described in U.S. patent application Ser. No. 15/486,769, filed Apr. 13, 2017, U.S. patent application Ser. No. 15/375,979, filed Dec. 12 , 2016, and U.S. patent application Ser. No. 15/375,866, filed Dec. 12, 2016, the contents of each of which are hereby incorporated by reference in their entirety. In some cases, this may include causing the matching engine to emit a notification to a rewards program mobile app of the user describing the reward, emitting an event to an affiliate clearinghouse computer system clearing the system to issue a reward (or otherwise prevent double payment), or performing this function of the clearinghouse for registered affiliates.

Some embodiments may provide a website (or other type of application program interface) by which the various above stakeholders may interrogate the transaction records. Examples include dashboards or other reports for merchants, publishers, rewards program operators, affiliate networks, payment networks, and the like.

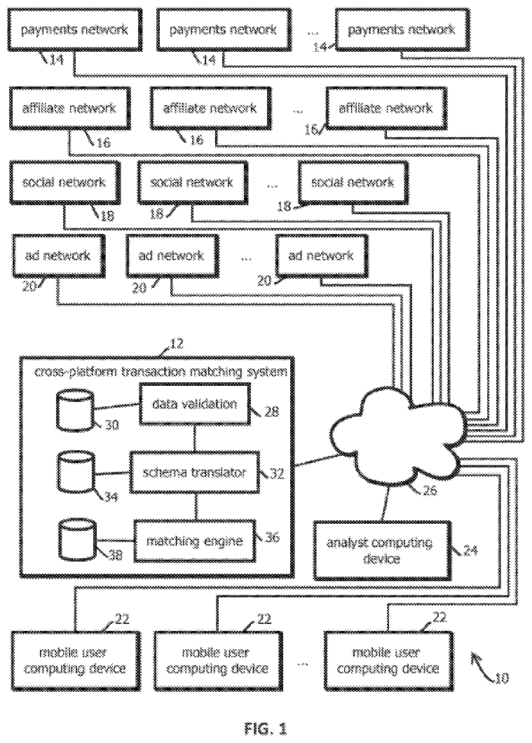

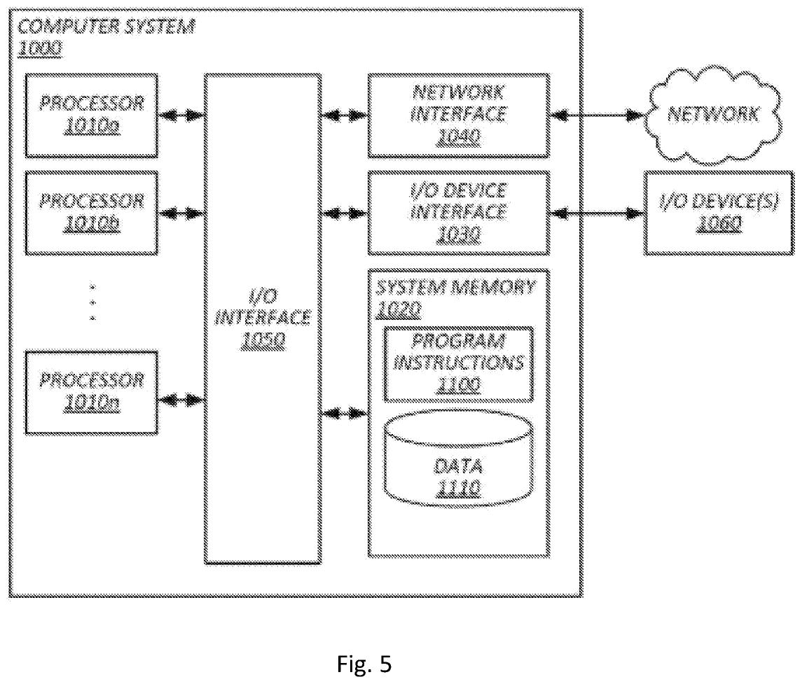

FIG. 1 shows an example of a computing environment 10 in which the above-described techniques may be implemented in exemplary embodiments. In some embodiments, the computing environment 10 may be a distributed computing environment, for instance, spanning a country, a continent, or the world. In some embodiments, the computing environment 10 may be implemented with a plurality of the computing devices described below with reference to FIG. 5 serving the roles of the different computing devices described with reference to FIG. 1 and above.

In some embodiments, the computing environment 10 may include a cross-platform transaction matching system 12, a plurality of collections of payments network computing devices 14, a plurality of collections of affiliate network computing devices 16, a plurality of collections of social network computing devices 18, and a plurality of collections of added network computing devices 20, each of which may be, or be part of, a respective distributed computing application. Some embodiments may further include a plurality of mobile user computing devices 22, an analyst computing device 24, and the Internet 26 and various other intermediary networks by which the presently described computing devices may communicate with one another. Three different instances of the various types of platforms, such as payment networks 14, affiliate networks 16, social networks 18, and ad networks 20 are shown, but embodiments may include substantially more, for example, 5 or more different payment networks, 10 or more different payment networks, or more. Similarly, the number of mobile user computing devices 22 and analyst computing devices 24 may scale according to the examples described above with reference to commercially relevant use cases.

In some embodiments, the various networks 14, 16, 18, and 20 may emit transactions, which may be ingested by the cross-platform transaction matching system 12 in accordance with the techniques described above. In some embodiments, the cross-platform transaction matching system 12 may include a data validation module 28, a data type definition specification repository 30, a schema translator module 32, a schema translation specification repository 34, a matching engine 36, and a unified transaction record repository 38. In some embodiments, these components may perform the operations described above by which data is validated, normalized, translated into a unified schema, and then transactions are matched to one another in collections of transactions corresponding to events. In some embodiments, resulting records may be analyzed via the analyst computing device 24, and notifications and other interactions with users may be effectuated via a mobile user computing devices 22, which may each execute an operating system and instance of the above-described rewards application, along with a web browser. Some embodiments may further communicate with other types of networks, communicate with other types of computing devices, and be implement in service of different types of cross-platform matching challenges, like those described above.

In another aspect of the disclosure, the offer matching and settlement system and method establishes how to associate specific marketing/advertising campaigns to completed sales transactions, in-store visits, web-site visits, or in-application interactions. The mechanisms for the conduct of the campaign, the presentation of the offer, the point-of-sale for the transaction, or the completion of the online/in-mobile integration are assumed to be independent. Included in this disclosure are embodiments that define the technical methods and processes for provisioning a token and tracking the token wherever and whenever a consumer interacts with the offer/advertisement and then conducts a transaction or a visit. A token in this instance can be any identifier to associate with a campaign, offer, or other marketing device, regardless of whether it is encrypted or not. Certain embodiments of the process for enabling this tracking includes:

1. Creating an offer/campaign specific token;

2. Enabling placement of the token in the advertising/marketing message or redeemable offer;

3. Monitoring and tracking propagation of the token and the associated message/offer;

4. Whenever and wherever the consumer chooses to transact/purchase the token can be monitored and associated to the channel where the consumer received the message/offer and then the completed transaction online/in-store/on-mobile;

5. Monitoring of multiple transactions and interactions including a specific consumer receiving multiple messages/offers;

6. When the token(s) are identified in association with a completed transaction/interaction there are processes for determining which of the messages/offers the consumer saw and in what time sequence and can associate the selection of a specific message/offer for the completion of the transaction/interaction;

7. In certain embodiments, tokens are cryptographically encrypted to ensure the security and uniqueness of each token;

8. Each token is for a single or multiple use, but can be securely and uniquely associated with a specific campaign, an interaction with a specific consumer, and the completion of a specific transaction/interaction. In particular, each offer is attached to each subscriber based upon data analytics which is then tokenized for tracking purposes.

9. Tokens can be used for many offer types including: one-time only, buy one/get one, buy X get Y, time specific with expiration or chained offers requiring multiple interactions for qualification of offer; and

10. Service management enables the merchant or advertiser making the offer or running the campaign to define which offer and publisher is honored—this eliminates multiple offer payments or discounts on any single consumer transaction.

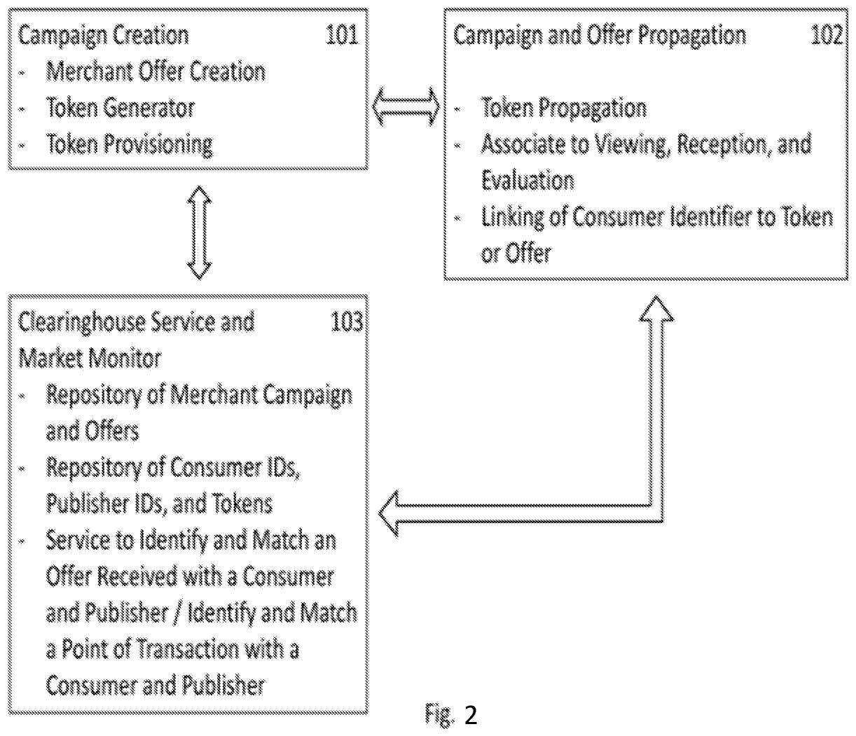

11. Campaign Creation services can enable in certain embodiments (further details of which are shown in FIG. 2 as element 101 and described below):
11.1. Merchant offer/incentive/coupon/discount (collectively “merchant offer”) creation;
11.2. Definition of Merchant and or Publisher rules for offer/incentive/coupon/discount delivery, receipt, presentation, qualification, adjudication, authorization, and settlement rules/terms/conditions. An example of a merchant offer that would take a number of these elements into account is, “Get 5% cash back on Monday (day of week) afternoon between the hours of 2:00 and 3:00 (time of day), after spending $75.00 (minimum amount spent), and on your third visit only (minimum visit).
11.3. Establishment of offer/incentive/coupon/discount funding terms with support for a single entity funding the offer/incentive/coupon/discount or multiple parties funding the offer/incentive/coupon/discount. An example of this is similar to the example in 11.2, however the system would add one simple offer rule that in addition to the 5%, the subscriber can get $1.00 off of a coke purchase. The merchant is identified as being responsible for the 5% and the manufacturer, in this case Coke Cola, is responsible for the $1.00. This offer is then tokenized and distributed.
11.4. Generation of cryptographic tokens providing an identifier for the Merchant Campaign and the associated offer/incentive/coupon/discount;
11.5. Provisioning of the offer/incentive/coupon/discount token to present it on multiple mediums/interfaces including:
   11.5.1. Online tracker for presentation of offer/incentive/coupon/discount in web sites;
   11.5.2. Mobile in-app tracker for offer/incentive/coupon/discount presentation within merchant, publisher or third party mobile applications; and
   11.5.3. Social Network tracker for offer/incentive/coupon/discount presentation in social media networks including Facebook, Instagram, Snap, WeChat, Twitter, LinkedIn.

12. Campaign and Offer/Incentive/Coupon/Discount Propagation services can enable in certain embodiments (further details of which are shown in FIG. 2 as element 102 and described below):
12.1. Placement of tokens in multiple advertising/messaging mediums:
   12.1.1. QR Code or numeric/alpha code on printed materials or images;
   12.1.2. Tracking pixel or other electronic identifier in web pages. The unique tracking Pixel that the merchant installs on their website that allows the offer management company to disallow double dipping and view/manage the online transaction based upon the payment network transaction flow.
   12.1.3. Cryptogram or alpha numeric identifier for tracking within mobile applications. The cryptogram works in the same was as described above in 12.1.2, but the cryptogram works on mobile phones; and
   12.1.4. Cryptogram or alpha numeric identifier for tracking within social media postings/messages.
12.2. Monitoring of token interactions to capture viewing, delivery, receiving events. Due to the pixel integrated on the websites, the platform is able to witness the transactions occurring on the site, associated with the offers that have been tokenized. This is also true within the platform subscriber user experience and extends the attributes of viewing and engagement elements.
   12.2.1. Online monitoring of interaction with web based tokens based on impressions or click-thru;
   12.2.2. Monitoring of mobile app events and callbacks to track user interactions and user activations of offer/incentive/coupon/discount; and
   12.2.3. Monitoring of social network feeds and APIs to track user interactions and user activations of offer/incentive/coupon/discount.
12.3. Linking of consumer identifier to user interactions and user activations of offer/incentive/coupon/discount. For example, in this case, the user is required to take an action, like “Activate” the offer that has been tokenized, is able to track and record all interactions and manage the outputs accordingly as associated with the business rules.
   12.3.1. Linking and persistent monitoring of consumer interaction with offer/incentive/coupon/discount online;
   12.3.2. Consumer activation with specific offer/incentive/coupon/discount ‘activation action’;
   12.3.3. Linking of Consumer Credit/Debit/Prepaid Primary Account Number (PAN) to a specific publisher and or offer/incentive/coupon/discount;
   12.3.4. Linking of Consumer social network identifier to an offer/incentive/coupon/discount; and
   12.3.5. Linking Of Consumer Digital Wallet (e.g., PayPal) identifier to an offer/incentive/coupon/discount.
12.4. Publisher management and monitoring services can enable in certain embodiments:
   12.4.1. Establishment of unique Publisher ID for entities (e.g., Yelp, Groupon, Ebates, ibotta, etc.) propagating or enabling receiving of offer/incentive/coupon/discount;
   12.4.2. Establishment of identifiers to link and monitor all consumers messaged, enrolled, or activated by a specific Publisher; and
   12.4.3. Linking the Publisher Identifier to the Merchant offer/incentive/coupon/discount being distributed by a specific publisher to the Merchant Identifier and the identifier for the offer/incentive/coupon/discount.

13. Clearinghouse and Transaction Monitoring services can enable in certain embodiments(further details of which are shown in FIG. 2 as element 103 and described below):
13.1. Repository with persistent storage and monitoring of all:
   13.1.1. Merchant Campaigns offers/incentives/coupons/discounts;
   13.1.2. Publisher Identifiers;
   13.1.3. Consumer Identifiers;
   13.1.4. Offer/incentive/coupon/discount Identifiers; and
   13.1.5. Tokens Provisioned
13.2. Listeners for identification of offer/incentive/coupon/discount presentation at point of transaction. Each listener is the pixel as defined earlier, and the listeners are also apart of all of the platform resources. The listeners identify and track all consumer interactions associated with a brand and that brands offer.
   13.2.1. Online—hooks in webpage and or payment page;
   13.2.2. Mobile App—hooks and or interfaces to mobile payment event or payment gateway;
   13.2.3. Social—hooks and or interfaces to social network commerce services or payment gateway;
   13.2.4. Payment and Debit Networks—direct interfaces to payment and debit network authorization services enabling matching of Consumer Identifier to Merchant Identifier and offer/incentive/coupon/discount identifier;
   13.2.5. Acquirer Processing Gateways—direct interfaces to acquirer processor, payment gateway, and payment facilitator transaction processing services enabling matching of Consumer Identifier to Merchant Identifier and offer/incentive/coupon/discount identifier; and
   13.2.6. Point-of-Sale Terminals and Servers—direct interfaces to point-of-sale devices, POS Servers, and terminal drivers transaction services enabling matching of Consumer Identifier to Merchant Identifier and offer/incentive/coupon/discount identifier.

14. Offer Matching, Qualification, Authorization, and Settlement services can enable in certain embodiments:
14.1. Invocation of matching at the time of a consumer event based upon triggers using the transaction monitoring services;
14.2. Immediate or batch matching of a transaction event online, in-app, in-social or In-store to the Merchant Identifier, Consumer Identifier, Publisher Identifier and the offer/incentive/coupon/discount identifier;
14.3. Invocation of logic to confirm qualification of the offer/incentive/coupon/discount presented by the consumer at the merchant at the time of transaction:
   14.3.1. Validation of offer/incentive/coupon/discount qualification based upon rules established by merchant and or publisher. Examples of the rules are the same as those set forth above in 11.2 and 11.3.
   14.3.2. Validation of the channel/medium/location of the transaction;
   14.3.3. Time of transaction;
   14.3.4. Source of the offer/incentive/coupon/discount being presented (including the Publisher ID);
   14.3.5. Device/terminal/network ID.
14.4. Application of any other rules or attributes established by the Merchant or Publisher at the time of Campaign setup and provisioning of the offer/incentive/coupon/discount;
14.5. Generation of authorization instructions for qualified offer/incentive/coupon/discount identifier;
14.6. Generation of settlement instructions for qualified offer/incentive/coupon/discount (including handling of offer/incentive/coupon/discount with multiple funders).

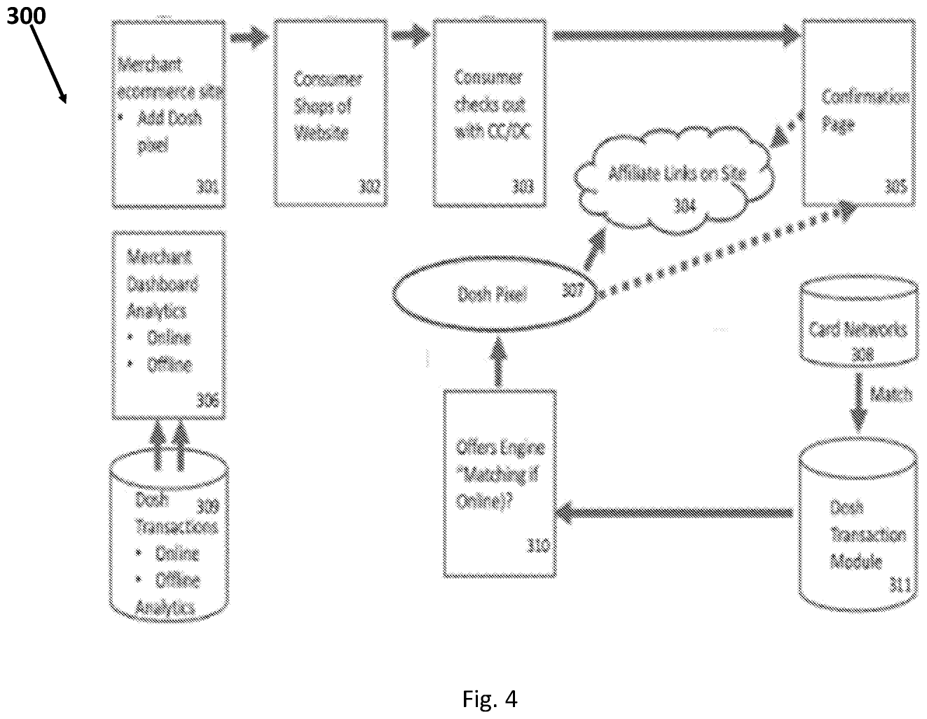

As shown in FIG. 2, certain embodiments of the disclosure contemplate separate functions that are coordinated to allow, among other things, for merchants to create advertising and marketing tools to incentivize consumers to conduct transactions with the business, to allow for the propagation and tracking of those incentives, and to serve as a clearinghouse and market monitor for the efficacy of the incentives. The processes shown in FIG. 1 may be implemented using the system and elements shown in FIG. 1 and/or the system shown in FIG. 4. This example illustrates the ability of a merchant to create a unique offer and distribute that offer through various mediums and publishers, identifying priority over various actions from Publishers and determining the publisher that has satisfied the merchant requirement. For example, the system would allow an offer to be created, similar to one that was defined in sections 11.2 and 11.3, and distributed to multiple publishers with the business rule that the publisher who has the consumer interact with the offer last, before the actual transaction occurs, is the publisher that is responsible for that transaction and is the publisher that receives credit for that transaction.

The campaign creation 101 portion of the system allows for the merchant to create offers for engagement with the consumers. The offers can be among other things discounts for a certain purchase, buy-one-get-one free, entertaining media segments that induce interaction, or other marketing devices created to encourage engagement. With each marketing tool, a device including a token is created to ensure the unique nature of the marketing device as used by the consumer. A token can be used for authentication of the merchant's offer and the consumer's rights to redeem the same. A token can be encrypted, plain text, or other appropriate means of unique (or quasi-unique) identification. As contemplated by the campaign and offer propagation segment 102, the token is distributed to potential consumers or targets of the marketing campaign. In certain embodiments of the techniques described herein, the system tracks the viewing, reception and evaluation of the offer and gathers the metadata related thereto. The customer can identified and linked to the token for a particular offer. Generally, there are multiple ways that an offer can be created and multiple ways that an offer can be redeemed. Similarly there are ways that can redeem multiple offers by a single transaction. As part of the techniques taught here, the system can serve as a clearing house service and market monitor of the offers 103. In the techniques taught herein, the system can act as a repository of merchant campaigns and offers. The techniques taught herein can serve as a repository of consumer identifications, publisher identifications, and tokens created. The techniques taught herein can serve as a means to identify and match an offer received with a consumer and the publisher, and identify and match a point of transaction with a consumer and publisher.

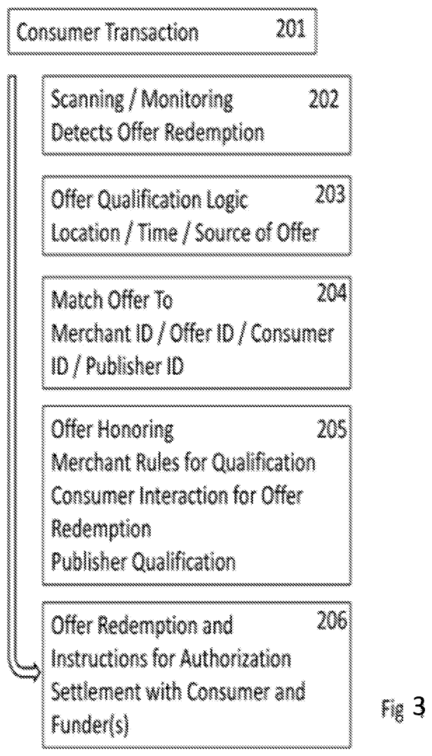

As shown in FIG. 3, certain embodiments of the techniques contemplate a consumer transaction 201. A consumer transaction can typically be a purchase, a redemption, or an interaction with an electronic advertisement such as the selection of a hyperlink. The system can scan and monitor for the redemption of an offer 202. The system can receive and deploy offer qualification logic as desired by, among other things, the desires of the merchants 203. The system can be input with logic to query certain information related to any offer, including the number of offers utilized, the uniqueness of the offer, prioritizing choices by the merchant, favored campaigns, or otherwise. The logic deployed by these techniques can prevent (or allow, or condition, as appropriate) “stacking” of offers, that is, allowing the redemption of multiple offers on a single consumer transaction. The logic can also prioritize multiple concurrent offers. Certain embodiments of the system can match a particular offer to one or more of a merchant identification number or code, an offer identification, a consumer identification, and a publisher identification 204. The logic can determine and or implement the rules for honoring offers and determined by the merchant or otherwise 205. For example, the logic may be similar to the exemplary offer rules as set forth in section 11.2 and 11.3 above. Upon a notification that an offer is appropriate to be redeemed, the techniques taught herein can be used to authorize and offer, redeem an offer, and provide instructions for settlement of the offer with the consumer and one or more funder 206. In this manner, certain embodiments of the system contemplate possible funding of an offer by the merchant or a particular manufacturer or producer.

FIG. 4 shows an illustrative merchant implementation of a simple version for online and in-store offers. Certain embodiments of this innovative solution will provide the following value propositions to any merchant both online and offline. In the platform shown in FIG. 4, the elements shown in FIG. 4 may be part of a platform 300 and the platform may be implemented using a plurality of computing resources that may be server computers, processors, etc. wherein a plurality of lines of instructions may be executed by the processor(s) of the platform to perform the processes and elements described below. In an embodiment, using the platform provided by the company Dosh™ as disclosed herein, merchants will now have the ability to merchant places a pixel on their website, managing affiliate links 301. The consumer visits the ecommerce site and shops like they normally do 302, from any browser for a product or a service (collectively a “saleable item”). In one embodiment, each consumer may have a computing device that is used to select and shop for the saleable item and that may couple to the platform. Each computing device may have a processor, memory, a display and circuits to connect to the platform. For example, each computing device may be a smartphone device, such as an Apple iPhone or Android operating system based device, a personal computer, a tablet computer, a tablet computer and the like.

The consumer checks out with their Dosh™ enabled credit card and/or their debit card 303. Dosh gets the merchant ID match and processes it through our matching system. The matching system comprising the matching engine 310, the card networks 308, and the Dosh™ transaction module 311 sends notice to the Dosh pixel 307 that there was a transaction that involved that consumer and that transaction at the merchant ecommerce site. The pixel is a unique process that incorporates the user experience online with the new card transaction functions and process of the platform. In the purest fashion, the merchant may add the pixel, as defined in previous sections, to their website. When there's a true transaction from the consumer, the platform gets that transaction from the credit card network, matches it to the associated pixel, and manages all the interactions, settlement, and analysis after that. This is unique to the industry and the current process in place by other companies. The Dosh pixel 307 removes the confirmation request that usually occurs with any affiliate links that are present by way of communication with a confirmation page 305. The Merchant Dashboard Analytics 306 receives Dosh™ transactions analytics from a Dosh™ database 309 that stores the particulars of any relevant information from the transaction, which could include the type of promotion or offer, the type of consumer, the type of device used, the type of purchase, the time and date of redemption, the identification of the particular consumer.

FIG. 5 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques 14 described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network. System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g.

within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “an element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method for matching and settling offers in a computerized system, the method, comprising:
providing a platform and a plurality of computing devices capable of being coupled to the platform, each computing device being used by a customer to shop a saleable item with an offer, the platform and each of the computing devices having a processor with a plurality of lines of instructions,
the platform being configured to:
receive a plurality of created merchant offers, each offer having a piece of logic for honoring each of the one or more of the plurality of created merchant offers;
create a plurality of tokens and associating each of the plurality of merchant offers with one or more of the created tokens;
distribute the one or more of the created merchant offers through electronic messages to a plurality of customers;
receive an indication that the consumer has selected at least one of the plurality of merchant offers;
link the consumer with a token associated with the selected at least one merchant offer;
upon a consumer transaction, determine whether the selected at least merchant offer is honored; and
receive messages related to the propagation or efficacy of the merchant offer.

2. The method of claim 1, wherein the platform is further configured to establish one or more funding terms from each offer.

3. The method of claim 1, wherein the platform is further configured to provision each token for one or more of a web site, a mobile application and a social media network wherein the offer is presented one or more of the website, the mobile application and the social media network.

4. The method of claim 1, wherein the platform is further configured to propagate each token to one of an advertising medium and a messaging medium.

5. The method of claim 4, wherein each token is selected from a group consisting of a QR cod, an alphanumeric code, a tracking pixel, a cryptogram for a mobile application and a cryptogram for a social media network.

6. The method of claim 4, wherein the platform is further configured to monitor an interaction of the token by the customer.

7. The method of claim 6, wherein monitoring the interaction further comprises one or more of online monitoring of web pages, monitoring mobile application events and monitoring social network feeds and application programming interfaces.

8. The method of claim 4, wherein the platform is further configured to identify a presentation of the offer at a transaction.

9. The method of claim 8, wherein identifying the presentation of the offer further comprises using hooks in one of a web page and a payment page, using one of hooks and interfaces in a mobile application or a payment gateway, using one of hooks and interfaces in a social network and a payment gateway, an interface to a payment authorization system, an interface to an acquirer processing system and an interface to a point of sale device.

10. The method of claim 1, wherein creating each token further comprises generating an encrypted token.

11. The method of claim 1, wherein creating each token further comprises generating one of a single use token and a multiple use token.

12. The method of claim 1, wherein each offer is selected from a group consisting of a one time offer, a buy one get one offer, buy one get another offer, a time limited offer and a chained offer.

13. An apparatus for matching and settling offers in a computerized system, the apparatus comprising:
a platform having a processor with a plurality of lines of instructions, the platform being configured to:
receive a plurality of created merchant offers, each offer having a piece of logic for honoring each of the one or more of the plurality of created merchant offers;
create a plurality of tokens and associating each of the plurality of merchant offers with one or more of the created tokens;
distribute the one or more of the created merchant offers through electronic messages to a plurality of customers;
receive an indication that the consumer has selected at least one of the plurality of merchant offers;
link the consumer with a token associated with the selected at least one merchant offer;
upon a consumer transaction, determine whether the selected at least merchant offer is honored; and
receive messages related to the propagation or efficacy of the merchant offer.

14. The apparatus of 13, wherein the platform is further configured to establish one or more funding terms from each offer.

15. The apparatus of claim 13, wherein the platform is further configured to provision each token for one or more of a web site, a mobile application and a social media network wherein the offer is presented one or more of the website, the mobile application and the social media network.

16. The apparatus of claim 13, wherein the platform is further configured to propagate each token to one of an advertising medium and a messaging medium.

17. The apparatus of claim 16, wherein each token is selected from a group consisting of a QR cod, an alphanumeric code, a tracking pixel, a cryptogram for a mobile application and a cryptogram for a social media network.

18. The apparatus of claim 16, wherein the platform is further configured to monitor an interaction of the token by the customer.

19. The apparatus of claim 18, wherein monitoring the interaction further comprises one or more of online monitoring of web pages, monitoring mobile application events and monitoring social network feeds and application programming interfaces.

20. The apparatus of claim 16, wherein the platform is further configured to identify a presentation of the offer at a transaction.

21. The apparatus of claim 20, wherein identifying the presentation of the offer further comprises using hooks in one of a web page and a payment page, using one of hooks and interfaces in a mobile application or a payment gateway, using one of hooks and interfaces in a social network and a payment gateway, an interface to a payment authorization system, an interface to an acquirer processing system and an interface to a point of sale device.

22. The apparatus of claim 13, wherein creating each token further comprises generating an encrypted token.

23. The apparatus of claim 13, wherein creating each token further comprises generating one of a single use token and a multiple use token.

24. The apparatus of claim 13, wherein each offer is selected from a group consisting of a one time offer, a buy one get one offer, buy one get another offer, a time limited offer and a chained offer.

25. A system for matching and settling offers in a computerized system, the system comprising:
a platform having a processor with a plurality of lines of instructions;
a plurality of computing devices capable of being coupled to the platform, each computing device being used by a customer to shop a saleable item with an offer and having a processor with a plurality of lines of instructions;
the platform configured to:
receive a plurality of created merchant offers, each offer having a piece of logic for honoring each of the one or more of the plurality of created merchant offers;
create a plurality of tokens and associating each of the plurality of merchant offers with one or more of the created tokens;
distribute the one or more of the created merchant offers through electronic messages to a plurality of customers;
each computing device being configured to select the saleable item having the offer, wherein the selection of the saleable item is communicated to the platform;
the platform being further configured to:
receive an indication that the consumer has selected at least one of the plurality of merchant offers;
link the consumer with a token associated with the selected at least one merchant offer;
upon a consumer transaction, determine whether the selected at least merchant offer is honored; and
receive messages related to the propagation or efficacy of the merchant offer.

26. The system of 25, wherein the platform is further configured to establish one or more funding terms from each offer.

27. The system of claim 25, wherein the platform is further configured to provision each token for one or more of a web site, a mobile application and a social media network wherein the offer is presented one or more of the website, the mobile application and the social media network.

28. The system of claim 25, wherein the platform is further configured to propagate each token to one of an advertising medium and a messaging medium.

29. The system of claim 28, wherein each token is selected from a group consisting of a QR cod, an alphanumeric code, a tracking pixel, a cryptogram for a mobile application and a cryptogram for a social media network.

30. The system of claim 28, wherein the platform is further configured to monitor an interaction of the token by the customer.

31. The system of claim 30, wherein the platform is further configured to one or more of online monitoring of web pages, monitoring mobile application events and monitoring social network feeds and application programming interfaces.

32. The system of claim 28, wherein the platform is further configured to identify a presentation of the offer at a transaction.

33. The system of claim 32, wherein identifying the presentation of the offer further comprises using hooks in one of a web page and a payment page, using one of hooks and interfaces in a mobile application or a payment gateway, using one of hooks and interfaces in a social network and a payment gateway, an interface to a payment authorization system, an interface to an acquirer processing system and an interface to a point of sale device.

34. The system of claim 25, wherein creating each token further comprises generating an encrypted token.

35. The system of claim 25, wherein creating each token further comprises generating one of a single use token and a multiple use token.

36. The system of claim 25, wherein each offer is selected from a group consisting of a one time offer, a buy one get one offer, buy one get another offer, a time limited offer and a chained offer.
